(19) United States
(12) Patent Application Publication
(10) Pub. No.: US 2003/0048821 A1
(43) Pub. Date: Mar. 13, 2003

(54) Current generating circuit and method

(76) Inventors: Shinichiro Iimura, Tokyo (JP); Hiroshi Ogawa, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(21) Appl. No.: 10/148,880

(22) PCT Filed: Oct. 11, 2001
(86) PCT No.: PCT/JP01/08934

(30) Foreign Application Priority Data
Oct. 13, 2000 (JP) 2000-31297

(51) Int. Cl. H01S 3/00

(52) U.S. Cl. 372/38.02

(57) ABSTRACT

A laser drive circuit for generating level drive currents corresponding to three or more types of laser powers have first to third signal generation circuits 110, 120, and 130 and a signal composing circuit 140. The first signal generation circuit 110 detects the output level of a semiconductor laser 50 at present by referring to a light reception signal Vp detected at a light receiving element 51 and generates a first drive current Ib corresponding to the bias power. The second signal generation circuit 120 generates a differential current Ibe smaller than the second drive current corresponding to the erase power by exactly the first drive current. The third signal generation circuit 130 generates a proportional current Ibw obtained by multiplying a differential current Ibe by a predetermined multiple. This multiple is defined by (write power-bias power)/(erase power-bias power). The signal composing circuit 140 generates the drive current of the semiconductor laser 50 by combining the currents Ib, Ibe, and Ibw in accordance with the operation mode.

### DESCRIPTION

1. Technical Field

The present invention relates to a current generation circuit and a method of the same, for example, a laser drive circuit and a laser drive method for driving a semiconductor laser used in an optical disk device.

2. Background Art

As a current generation circuit, a laser drive circuit will be explained as an example.

Various optical disk devices are known, but there are many general optical disk devices having a recording function for recording data on an optical disk, an erasing function for erasing the data recorded on the optical disk, and a reproduction function for reproducing the data recorded on the optical disk.

An optical disk device usually performs the recording, reproduction, or erasure of data by focusing a laser beam on the optical disk using a single semiconductor laser. Generally, the laser powers (output levels of the laser) at the time of recording, time of reproduction, and time of erasure are different from each other. The laser power at the time of recording is higher than the laser power at the time of erasure, while the laser power at the time of erasure is higher than the laser power at the time of reproduction.

FIGS. 1A and 1B are waveform diagrams illustrating waveforms of a data write pulse of a semiconductor laser in a case of focusing a laser beam from the semiconductor laser inside the optical disk device to a phase change type optical disk to record data.

FIG. 1A is a waveform diagram of the change of waveform of the recording data. A pulse width Twd indicates a data length of the recording data.

FIG. 1B is a waveform diagram of the waveform (or intensity) of the laser beam corresponding to the recording use data illustrated in FIG. 1A.

In the write data pulse at the time of recording shown in FIGS. 1A and 1B, the minimum period of the write pulse is defined as T. The width T_{WD} of the write data pulse illustrated in FIG. 1A is 8T and 3T. In FIG. 1B, the minimum pulse width Tₘₚ in the minimum period T equals 0.4×T, the maximum pulse width Tₜₒₚ equals 0.5×T, and a width T_{c1} for resetting (clearing) the pulse to the bias power Pb after writing equals 0.6×T.

The laser power (laser output level) at the time of recording shown in FIG. 1B is comprised by three types of levels. Namely, these are three types of a first level comprised of the bias power level Pb, a second level comprised of an erase power level Pe, and a third level comprised of a write power level Pw. A relationship of 0<Pb<Pe<Pw stands.

FIG. 2 is a block diagram of the configuration illustrating a laser drive circuit in an optical disk device.

A laser drive circuit 90 illustrated in FIG. 2 has first to third signal generation circuits 10, 20, and 30 and a signal composing circuit 40.

The laser drive circuit 90 cooperates with a semiconductor laser 50, a light receiving element 51, a current/voltage conversion circuit (I/V) 52, and a controlling means 60 to make the semiconductor laser 50 emit laser beams for the reading of data from an optical disk of the optical disk device, erasure of data, and writing of data. In other words, the optical disk device has the semiconductor laser 50, light receiving element 51, current/voltage conversion circuit 52, controlling means 60, and laser drive circuit 90.

The first signal generation circuit 10 has a sample and hold circuit (SHb) 11, adder (subtractor) circuit 12 for calculating an error, loop filter (LPb) 13, voltage/current conversion circuit (V/Ib) 14, and target value setting circuit (SETb) 15 for applying a target value (reference value) to the adder circuit 12.

The second signal generation circuit 20 has a sample and hold circuit (SHe) 21, adder (subtractor) circuit 22 for calculating a deviation, loop filter (LPe) 23, voltage/current conversion circuit (V/Ie) 24, and target value setting circuit (SETe) 25 for applying the target value (reference value) to the adder circuit 22.

The third signal generation circuit 30 has a sample and hold circuit (SHw) 31, adder (subtractor) circuit 32 for calculating a deviation, loop filter (LPw) 33, voltage/current conversion circuit (V/Iw) 34, and target value setting circuit (SETW) 35 for applying the target value (reference value) to the adder circuit 22.

The signal composing circuit 40 has three switching circuits 41 to 43 and two adder circuits 44 and 45.

The first switching circuit 41 is provided between the adder circuit 45 and the voltage/current conversion circuit 14 of the first signal generation circuit 10. The second switching circuit 42 is provided between the adder circuit 44 and the voltage/current conversion circuit 24 of the second signal generation circuit 20. The third switching circuit 43 is provided between the adder circuit 44 and the voltage/current conversion circuit 34 of the third signal generation circuit 30.

The signal composing circuit 40 selects current signals Ib, Ie, and Iw output from the first to third signal generation circuits 10, 20, and 30 via the first to third switching circuits 41 to 43 among which only one is turned on by a control signal Sc of the controlling means 60 and appropriately adds them to generate a drive current Id of the semiconductor laser 50.

The first to third signal generation circuits 10 to 30 have the same circuit configurations and independently operate.

The controlling means 60 outputs the control signal Sc shown in Table 1 so as to select one of the first to third switching circuits 41 to 43 in the signal composing circuit 40 so that a laser power L0 is output from the semiconductor laser 50 in accordance with the operation of the optical disk device. Accordingly, the outputs of the first to third signal generation circuits 10, 20, and 30 are independently applied to the semiconductor laser 50.

TABLE 1

| | Reproduction | Erase | Write |
|---|---|---|---|
| Laser power | Pb | Pe | Pw |
| L₀ | | | |
| First SW | ON | OFF | OFF |
| circuit 41 | | | |
| Second SW | OFF | ON | OFF |
| circuit 42 | | | |
| Third SW | OFF | OFF | ON |
| circuit 43 | | | |

Note that, the controlling means 60 outputs the control signal Sc so that the switching circuits 41 to 43 are turned on or off in accordance with the data length of the recording data. For example, for the recording data of FIG. 1A, the control signal Sc for performing the ON/OFF operation is output from the controlling means 60 so that the write pulse shown in FIG. 1B is output from the semiconductor laser 50.

The light receiving element 51 is comprised by for example a photodiode generating an electric signal in accordance with the light. A power supply voltage V_{C} is supplied to a cathode of this photodiode. The photodiode, that is, the light receiving element 51, is inversely biased.

The light receiving element 51 receives part of the laser beam output from the semiconductor laser 50 and converts it to an electrical signal to generate a light reception signal Ip of the current signal corresponding to the intensity of the received laser beam.

The current/voltage conversion circuit (I/V) 52 converts the light reception signal Ip of the current signal generated by the light receiving element 51 to a light reception signal Vp of the voltage signal.

The semiconductor laser 50 has a nonlinear characteristic illustrated in FIG. 4 and focuses light of the bias power Pb, erase power Pe, and the write power Pw on a not illustrated optical disk. The semiconductor laser 50 has a nonlinear characteristic as illustrated in FIG. 4, and the bias power level Pb, erase power level Pe, and the write power level Pw exhibit straight lines. However, due to the temperature characteristic, aging, etc. around the semiconductor laser 50, the changes of the characteristics as illustrated by curves A1 and A2 occur. Accordingly, the laser drive circuit 90 outputs the drive current Id to the semiconductor laser 50 so that the bias power level Pb, erase power level Pe, and the write power level Pw are ensured even if there is a change in the characteristics of the semiconductor laser 50.

The first signal generation circuit 10 generates the first drive current Ib so that the light reception signal Vp becomes a level by which the output power L₀ of the semiconductor laser 50 indicates the bias power level Pb.

In the first signal generation circuit 10, the sample and hold circuit 11 samples the light reception signal Vp by a predetermined period based on sampling theory and generates an output signal S11 indicating the sample value. As the sample and hold circuit 11, use can be also made of a bottom hold circuit.

The target value setting circuit 15 generates a first target signal S15 so that the first drive current Ib by which the output power L₀ of the semiconductor laser 50 indicates the bias power level Pb is output from the first signal generation circuit 10 and outputs this first target signal S15 to the adder circuit 12.

The adder circuit 12 subtracts the output signal S11 of the sample and hold circuit 11 from the first target signal S15 to generate a differential signal S12 (=S15−S11) indicating a deviation between them.

The loop filter 13 generates a filter signal S13 obtained by attenuating a high frequency component of the differential signal S12 and supplies that filter signal S13 to the voltage/current conversion circuit 14.

The voltage/current conversion circuit 14 converts the filter signal S13 of the voltage signal to a current signal Ib.

The second signal generation circuit 20 generates a second drive current Ie so that the light reception signal Vp becomes a level at which the output power L₀ of the semiconductor laser 50 indicates the erase power level Pe.

The operation of the second signal generation circuit 20 is similar to the operation of the first signal generation circuit 10 explained above. Below, only the differences from the operation of the first signal generation circuit 10 will be explained.

The target value setting circuit 25 generates a second target signal S25 indicating the target value (reference value) of an output signal S21 of the sample and hold circuit 21 and outputs this second target signal S25 to the adder circuit 22.

The third signal generation circuit 30 generates a third drive current Iw by which the light reception signal Vp becomes a level at which the output power L₀ of the semiconductor laser 50 indicates the write power level Pw.

The operation of the third signal generation circuit 30 is similar to the operation of the first signal generation circuit 10 explained above. Below, only the differences from the operation of the first signal generation circuit 10 will be explained.

The target value setting circuit 35 generates a third target signal S35 indicating the target value (reference value) of an output signal S31 of the sample and hold circuit 31 and outputs this third target signal S35 to the adder circuit 32.

An anode of the semiconductor laser 50 receives as input the drive signal Id from the signal composing circuit 40. The cathode is grounded and becomes a ground potential GND. This semiconductor laser 50 emits the laser beam with the laser power L₀ in accordance with the drive current Id supplied to the anode.

Simplification of the circuit configuration of the laser drive circuit 90 illustrated in FIG. 2 has been demanded.

First, the first signal generation circuit 10 for generating the drive current Ib for the bias power Pb, the second signal generation circuit 20 for generating the drive current Ie for the erase power Pe, and the third signal generation circuit 30 for generating the drive current Iw for the write power Pw independently operate, but have similar circuit configurations, so simplification of the circuit configurations has been demanded.

Next, the signal composing circuit 40 has three switching circuits 41 to 43 for selecting the drive currents Ib, Ie, and Iw, so simplification of the circuit configuration has been demanded.

Note that, a laser drive circuit used in an optical disk device was explained as an example of the current generation circuit of the present invention, but the invention is not limited to a laser drive circuit. There is demand to overcome similar problems to the above in other current generation circuits as well.

### DISCLOSURE OF THE INVENTION

A first object of the present invention is to simplify the circuit configuration of a current generation circuit for outputting three or more types of drive currents having linear relationships.

A second object of the present invention is to provide a method useable in the current generation circuit.

A third object of the present invention is to provide an optical disk device preferred when the above current generation circuit is used as a laser drive circuit.

According to a first aspect of the present invention, there is provided a current generation circuit comprising a first signal generation circuit receiving as input a signal indicating an operation state of a drive device having a nonlinear operation characteristic and used in a characteristic portion indicated by a straight line and generating a first drive current by which an output power of the drive device indicated by the signal indicating an operation state becomes a first power level based on a first target value, a second signal generation circuit receiving as input a signal indicating an operation state of the drive device and generating a corrected second drive current smaller than the first drive current from a second drive current by which the output power of the semiconductor laser indicated by the signal indicating the operation state becomes a second power level higher than the first power level based on a second target value, a third signal generation circuit for generating a corrected third drive current smaller than the first drive current from a third drive current by which the output power of the drive device becomes a third power level higher than the second power level by multiplying the corrected second drive current with a predetermined multiple, and a signal composing circuit having a first switching circuit for selecting the output signal of the third signal generation circuit, a second switching circuit for selecting the output signal of the second signal generation circuit, and an adder circuit for adding the signal selected by the first switching circuit, the signal selected by the second switching circuit, and the output of the first signal generation circuit and supplying the result of the adder circuit to the drive device, in the signal composing circuit the first and second switching circuits being OFF in a first operation mode, the first switching circuit being in an ON state and the second switching circuit being OFF in a second operation mode, and the first switching circuit being OFF and the second switching circuit becoming the ON state in a third operation mode.

The signal composing circuit can further have a second adder circuit for adding the signal selected by the first switching circuit and the signal selected by the second switching circuit and outputting the result to the adder circuit.

The predetermined multiple is defined by the following equation:

(Third power level−first power level)/(Second power level−first power level)

According to a second aspect of the present invention, there is provided a laser drive circuit comprising a first signal generation circuit for receiving as input a light reception signal from a light receiving element generating a light reception signal in accordance with light emitted from a semiconductor laser and generating a first semiconductor laser drive current by which the output power of the semiconductor laser indicated by the light reception signal becomes a first power level based on a first target value, a second signal generation circuit receiving as input the light reception signal and generating a corrected second drive current smaller than the first semiconductor laser drive current from a second semiconductor laser drive current by which the output power of the semiconductor laser indicated by the light reception signal becomes a second power level higher than the first power level based on a second target value, a third signal generation circuit for generating a corrected third drive current smaller than the first semiconductor laser drive current from a third semiconductor laser drive current by which the output power of the semiconductor laser becomes a third power level higher than the second power level by multiplying the corrected second drive current by a predetermined multiple, and a signal composing circuit having a first switching circuit for selecting the output signal of the third signal generation circuit, a second switching circuit for selecting the output signal of the second signal generation circuit, and an adder circuit for adding the signal selected by the first switching circuit, the signal selected by the second switching circuit, and the output of the first signal generation circuit and supplying the result of the adder circuit to the semiconductor laser, in which signal composing circuit the first and second switching circuits are OFF in a first operation mode, the first switching circuit is in an ON state and the second switching circuit is OFF in a second operation mode, and the first switching circuit is OFF and the second switching circuit becomes the ON state in a third operation mode.

The signal composing circuit can further have a second adder circuit for adding the signal selected by the first switching circuit and the signal selected by the second switching circuit and outputting the result to the adder circuit.

Preferably, the laser drive circuit is used in an optical disk device, the laser beam emitted from the semiconductor laser is focused on a phase change type optical disk and the light receiving element, the first power level is the level of the bias power, the second power level is the level of the erase power for erasing the data recorded on the optical disk, the third power level is the level of the write power for recording the data on the optical disk, the first operation mode is the mode for driving the semiconductor laser at the level of the bias power, the second operation mode is the mode for driving the semiconductor laser at the level of the erase power, the third operation mode is the mode for driving the semiconductor laser by the write level, and the first and second switching circuits are driven ON or OFF in accordance with an erase pulse waveform and a write waveform.

According to a third aspect of the present invention, there is provided an optical disk device comprising a phase change type optical disk, a semiconductor laser for focusing a laser beam on the optical disk, a light receiving element for generating a light reception signal in accordance with the emitted light of the semiconductor laser, a controlling means for controlling reading of the data from the optical disk, erasure of the data on the optical disk, and writing of the data to the optical disk, and the laser drive circuit. The controlling means makes the first and second switching circuits turn OFF in the read mode of the data, makes the first switching circuit turn ON or OFF in accordance with an erase waveform in a state where the second switching circuit is turned OFF in the erase mode, and makes the second switching circuit turn ON or OFF in accordance with a write waveform in a state where the first switching circuit is turned OFF in the write mode.

According to a fourth aspect of the present invention, there is provided a laser drive device comprising a first signal generation means for receiving as input a light reception signal from a light receiving element generating a light reception signal in accordance with light emitted from a semiconductor laser and generating a first semiconductor laser drive current by which the output power of the semiconductor laser indicated by the light reception signal becomes a first power level based on a first target value, a second signal generation means receiving as input the light reception signal and generating a corrected second drive current smaller than the first semiconductor laser drive current from a second semiconductor laser drive current by which the output power of the semiconductor laser indicated by the light reception signal becomes a second power level higher than the first power level based on a second target value, a third signal generation means for generating a corrected third drive current smaller than the first semiconductor laser drive current from a third semiconductor laser drive current by which the output power of the semiconductor laser becomes a third power level higher than the second power level by multiplying the corrected second drive current by a predetermined multiple, and a signal composing means having a first switching means for selecting the output signal of the third signal generation means, a second switching means for selecting the output signal of the second signal generation means, and an adder means for adding the signal selected by the first switching means, the signal selected by the second switching means, and the output of the first signal generation means and supplying the result of the adder means to the semiconductor laser, in which signal composing means the first and second switching means are OFF in a first operation mode, the first switching means is in an ON state and the second switching means is OFF in a second operation mode, and the first switching means is OFF and the second switching means becomes ON in a third operation mode.

The signal combining means can further have a second adder means for adding the signal selected by the first switching means and the signal selected by the second switching means and outputting the result to the adder means.

According to a fifth aspect of the present invention, there is provided an optical disk device comprising a phase change type optical disk, a semiconductor laser for focusing a laser beam on an optical disk, a light receiving element for generating a light reception signal in accordance with the emitted light of the semiconductor laser, a controlling means for controlling reading of the data from the optical disk, erasure of the data on the optical disk, and writing of the data to the optical disk, and the laser drive means. The controlling means operates the first and second switching means to OFF in a read mode of the data, makes the first switching means turn ON or OFF in accordance with an erase waveform in a state where the second switching means is turned OFF in the erase mode, and makes the second switching means turn ON or OFF in accordance with a write waveform in a state where the first switching means is turned OFF in the write mode.

According to a sixth aspect of the present invention, there is provided a laser drive method including by (a) a step of inputting a light reception signal from a light receiving element generating a light reception signal in accordance with light emitted from a semiconductor laser, (b) a step of generating a first semiconductor laser drive current by which the output power of the semiconductor laser indicated by the input light reception signal becomes a first power level based on the first target value, generating a corrected second drive current smaller than the first semiconductor laser drive current from a second semiconductor laser drive current by which the output power of the semiconductor laser indicated by the light reception signal becomes a second power level higher than the first power level based on the second target value, and generating a corrected third drive current smaller than the first semiconductor laser drive current from a third semiconductor laser drive current by which the output power of the semiconductor laser becomes a third power level higher than the second power level by multiplying the corrected second drive current by a predetermined magnitude, and (c) a step of outputting the first semiconductor laser drive current in a first operation mode, adding the first semiconductor laser drive current and the corrected second drive current and outputting the same in a second mode, and adding the first semiconductor laser drive current and the corrected third drive current and outputting the same in a third mode.

### BRIEF DESCRIPTION OF THE DRAWINGS

The above objects and features of the present invention will become clearer by embodiments of the present invention explained by referring to the attached drawings.

FIG. 1 is a waveform diagram illustrating a laser power of a semiconductor laser in a case of focusing a laser beam from a semiconductor laser inside an optical disk device on a phase change type optical disk to record data.

FIG. 2 is a block diagram of the configuration illustrating a laser drive circuit in the optical disk device.

FIG. 3 is a block diagram of the configuration showing a first embodiment of a laser drive circuit as an example of a current generation circuit according to the present invention.

FIG. 4 is a graph illustrating the characteristics of the semiconductor laser in FIG. 3.

FIG. 5 is a block diagram of the configuration showing a second embodiment of a laser drive circuit as an example of the current generation circuit according to the present invention.

FIG. 6 is a flowchart showing a laser drive method carried out in the laser drive circuits of FIG. 3 and FIG. 5.

### BEST MODE FOR WORKING THE INVENTION

Below, an explanation will be made of preferred embodiments of the current generation circuit of the present invention by referring to the attached drawings.

As a preferred embodiment of the current generation circuit of the present invention, for example, a laser drive circuit providing three types of drive currents having linear relationships in a use region while having nonlinear characteristics such as in a semiconductor laser and used in for example the above optical disk device will be explained.

Note that, it is self-evident from the following preferred embodiments that the current generation circuit of the present invention can be applied to various fields providing drive currents to a device providing three types of drive currents having linear relationships in the use region while having nonlinear characteristics.

First Embodiment

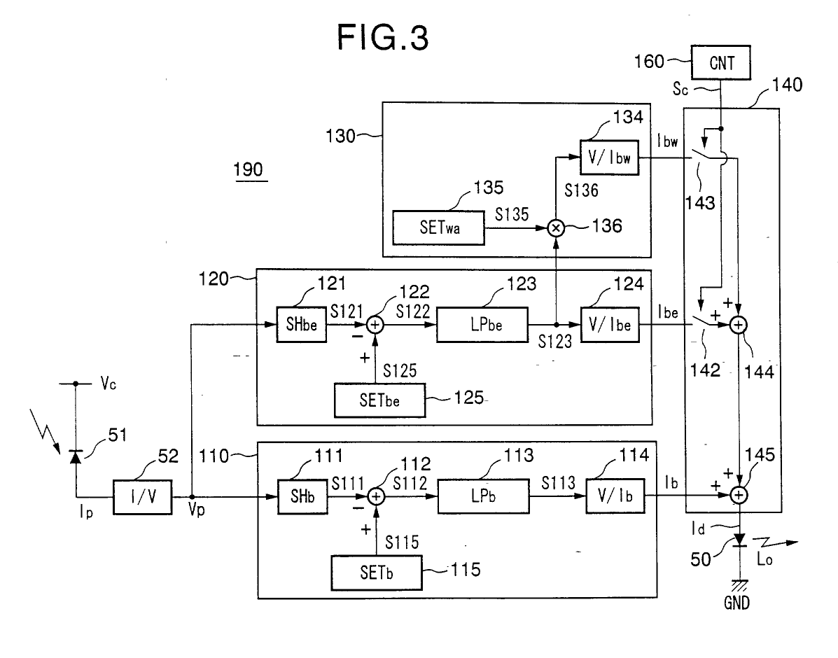

FIG. 3 is a block diagram of the configuration of a first embodiment of a laser drive circuit as a preferred embodiment of the current generation circuit according to the present invention.

A laser drive circuit 190 illustrated in FIG. 3 is arranged in an optical disk device for the writing, erasure, and reproduction of data using for example a phase change type optical disk as the recording medium and drives a semiconductor laser for generating laser beams to be focused on the phase change type optical disk.

The laser drive circuit 190 illustrated in FIG. 3 has first to third signal generation circuits 110, 120, and 130 and a signal composing circuit 140.

The laser drive circuit 190 works with the semiconductor laser 50, light receiving element 51, current/voltage conversion circuit (I/V) 52, and controlling means 160 to make the semiconductor laser 50 emit laser beams for the reading of data from the optical disk of the optical disk device, erasure of data, and writing of data. In other words, the optical disk device has the semiconductor laser 50, light receiving element 51, current/voltage conversion circuit 52, controlling means 160, and laser drive circuit 190.

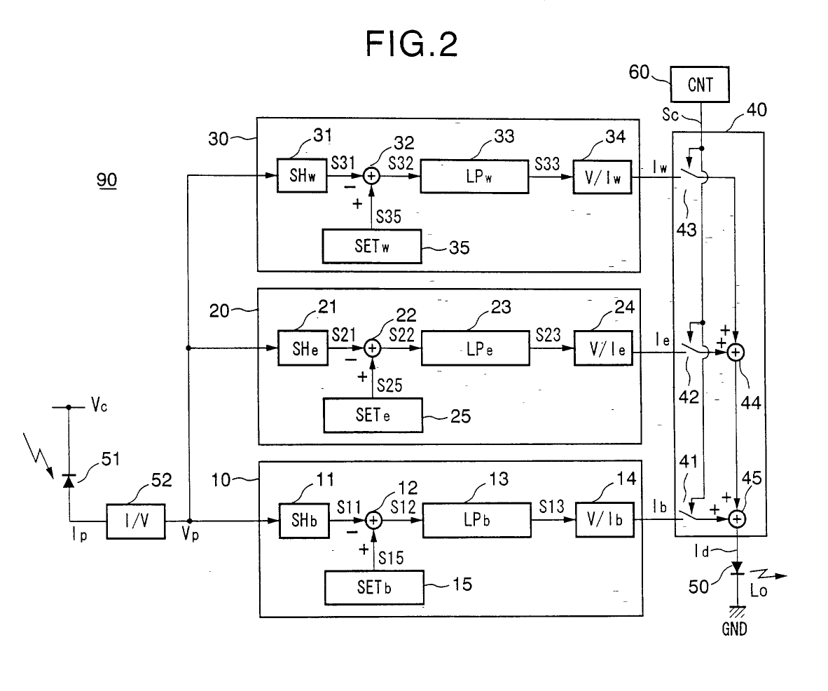

The semiconductor laser 50, light receiving element 51, and the current/voltage conversion circuit (I/V) 52 are substantially the same as those explained referring to FIG. 2.

The first signal generation circuit 110 has substantially the same circuit configuration as that of the first signal generation circuit 10 explained by referring to FIG. 2 and generates a bias current Ib as the first laser drive current based on a detection current Ip of the light receiving element 51. The first signal generation circuit 110 has a sample and hold circuit (SHb) 111, adder (subtractor) circuit 112, loop filter (LPb) 113, voltage/current conversion circuit (V/Ib) 114, and target value setting circuit (SETb) 115.

The second signal generation circuit 120 is basically the same as the second signal generation circuit 20 explained by referring to FIG. 2 and generates a corrected erase signal Ibe as the second laser drive current corrected based on the detection current Ip of the light receiving element 51.

Note that the corrected erase current Ibe is different from the erase current Ie explained by referring to FIG. 2, and Ibe=Ie−Ib. Ib is the bias current of the first laser drive current generated at the first signal generation circuit 110.

Further, the second signal generation circuit 120 illustrated in FIG. 3 is different from the second signal generation circuit 20 illustrated in FIG. 2 and supplies an intermediate output signal to the third signal generation circuit 130.

The second signal generation circuit 120 has a sample and hold circuit (SHbe) 121, adder (subtractor) circuit 122, loop filter (LPbe) 123, voltage/current conversion circuit (V/Ibe) 124, and target value setting circuit (SETbe) 125.

The third signal generation circuit 130 has a circuit configuration greatly different from the third signal generation circuit 30 explained by referring to FIG. 3. In the third signal generation circuit 30 of FIG. 2, the sample and hold circuit (SHbe) 31, adder circuit 32, and loop filter (LPbe) 33 are deleted, and a voltage/current conversion circuit (V/Ibw) 134, multiple setting circuit (SETwa) 135, and multiplier circuit 136 are provided. Further, the multiplier circuit 136 is supplied with the output signal of the loop filter (LPbe) 123 of the second signal generation circuit 120.

The corrected third drive current Ibw output from the third signal generation circuit 130 is different from the third drive current Iw explained by referring to FIG. 2, and Ibw=Iw−Ib.

The signal composing circuit 140 has two switching circuits 142 and 143 and two adder circuits 144 and 145. Compared with the signal composing circuit 40 explained by referring to FIG. 2, the number of the switching circuits is smaller by one.

The signal composing circuit 140 generates the drive current Id of the semiconductor laser 50 in accordance with the target by combining the current signals Ib, Ibe, and Ibw under the control of the controlling means 160.

The switching circuit 142 is provided between the adder circuit 144 and the voltage/current conversion circuit 124. The switching circuit 143 is provided between the adder circuit 144 and the voltage/current conversion circuit 134.

In the controlling means 160, the processing content is different from that of the controlling means 60 illustrated in FIG. 2.

The switching circuits 142 and 143 perform the ON/OFF operation as follows shown in Table 2 based on the control signal Sc output from the controlling means 160 for designating the target value of the laser power L₀:

TABLE 2

| | Reproduction | Erase | Write |
|---|---|---|---|
| Laser power | Pb | Pe | Pw |
| L₀ | | | |
| SW circuit | OFF | ON | OFF |
| 142 | | | |
| SW circuit | OFF | OFF | ON |
| 143 | | | |

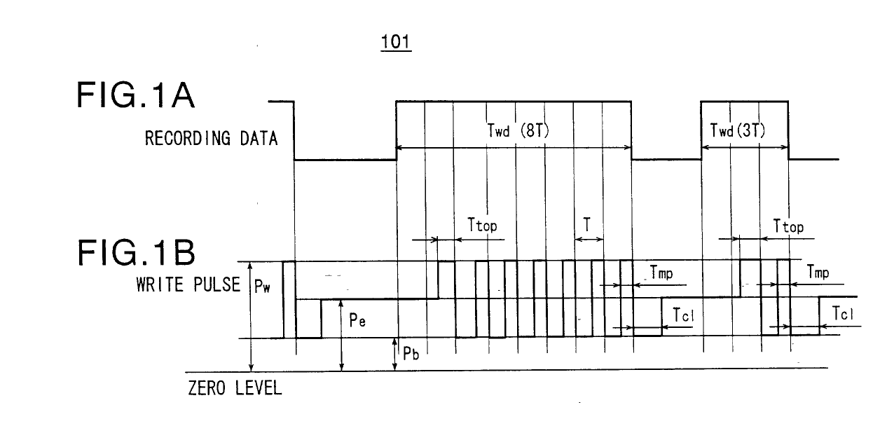

The controlling means 160 outputs for example the control signal Sc so that the write pulse shown in FIG. 1B is output from the semiconductor laser 50 with respect to the recording data of FIG. 1A and performs the ON/OFF operation of the switching circuits 142 and 143.

When driving the semiconductor laser 50 by the bias power Pb, that is, at the time of reproduction of data from the optical disk, the switching circuits 142 and 143 become the OFF state by the control signal Sc output from the controlling means 160. As a result, the adder circuit 145 supplies only the current signal Ib as the output of the first signal generation circuit 110 to the semiconductor laser 50.

When driving the semiconductor laser 50 by the erase power Pe, the switching circuit 142 becomes the ON state and the switching circuit 143 becomes the OFF state by the control signal Sc output from the controlling means 160. As a result, the adder circuit 145 supplies the result obtained by adding the current signal Ib of the output of the first signal generation circuit 110 and the second current signal Ibe of the output of the second signal generation circuit 120 and passed through the adder circuit 144 to the semiconductor laser 50 as the drive current Id.

When driving the semiconductor laser 50 by the write power Pw, the switching circuit 142 becomes the OFF state and the switching circuit 143 becomes the ONF state by the control signal Sc output from the controlling means 160. As a result, the adder circuit 145 supplies the result obtained by adding the current signal Ib of the output of the first signal generation circuit 110 and the third current signal Iwe of the output of the third signal generation circuit 130 and passed through the adder circuit 144 to the semiconductor laser 50 as the drive current Id.

The light receiving element 51 is comprised by for example a photodiode in the same way as explained by referring to FIG. 2. The power supply voltage Vc is supplied to the cathode of this photodiode, that is, the light receiving element 51 as the photodiode is inversely biased.

The light receiving element 51 receives part of the laser beam output from the semiconductor laser 50 and converts it to an electrical signal to generate a light reception signal Ip of the current signal in accordance with the intensity of the received laser beam.

Note that the semiconductor laser 50 emits front light used for the writing etc. of data to the optical disk and back light received at the light receiving element 51 and used for monitoring the level thereof. The light receiving element 51 usually receives the back light of the semiconductor laser 50.

The current/voltage conversion circuit (I/V) 52 converts the light reception signal Ip generated by the light receiving element 51 to the light reception signal Vp of the voltage signal.

The first signal generation circuit 110 generates a first drive current by which the output power L₀ of the semiconductor laser 50 indicated by the light reception signal Vp becomes the bias power level Pb, that is, the bias current Ib, based on the target value of the target value setting circuit 115.

In the first signal generation circuit 110, the sample and hold circuit 111 samples and holds the light reception signal Vp by the predetermined period and generates an output signal S111 indicating the sample value. As the sample and hold circuit 111, use can be also made of a bottom hold circuit.

The target value setting circuit 115 generates a first drive current, that is, a target value (or reference value) signal S115 for generating the bias current Ib, and outputs this first target signal S115 to the adder circuit 112.

The adder circuit 112 subtracts the output signal S111 of the sample and hold circuit 111 from the first target signal S115 to generates a differential signal S112 (=S115−S111) indicating the deviation between them.

The loop filter 113 generates a filter signal S113 for attenuating the high frequency component of the difference signal S112 and passing its low frequency component and supplies the related filter signal S113 to the voltage/current conversion circuit 114. The loop filter 113 is a low pass filter.

The voltage/current conversion circuit 114 converts the filter signal S113 of the voltage signal to the bias current signal Ib of the current signal.

The second signal generation circuit 120 generates the current signal (corrected erase current) Ibe (Ibe=Ie−Ib) of the differential current smaller than the second drive current Ie by which the output power Lo of the semiconductor laser 50 indicated by the light reception signal Vp becomes the erase power level Pe by exactly the first drive current (bias current signal Ib).

The reason for the generation of the current signal (corrected erase current) I_{be} smaller than the second drive current Ie by exactly the first drive current (bias current signal) Ib in the second signal generation circuit 120 is that the first drive current (bias current signal Ib) output from the first signal generation circuit 110 is added to the current signal I_{be} output from the second signal generation circuit 120 in the adder circuit 145 in the signal composing circuit 140 and the drive current Id of the semiconductor laser 50 becomes the second drive current Ie.

The circuit configuration of the second signal generation circuit 120 is similar to the circuit configuration of the first signal generation circuit 110, and the circuit operation thereof is similar to the operation of the first signal generation circuit 110 explained above.

The sample and hold circuit 121 samples the light reception signal Vp by the predetermined period, holds that value, and generates an output signal S121 indicating the sample value.

The target value setting circuit 125 generates a second target signal S125 indicating the target value of the current signal (corrected erase current) I_{be} of the differential current smaller than the second drive current Ie by which the output power L₀ of the semiconductor laser 50 becomes the erase power level Pe by exactly the first drive current (bias current signal I_{b}) and outputs this second target signal S125 to the adder circuit 122.

The adder circuit 122 subtracts the output signal S121 of the sample and hold circuit 121 from the second target signal S125 to generates a differential signal S122 (=S125−S121) indicating the deviation thereof.

The loop filter 123 generates a filter signal S123 obtained by attenuating the high frequency component of the differential signal S122 and passing its low frequency component and supplies the related filter signal S123 to the voltage/current conversion circuit 124 and the multiplier circuit 126. The loop filter 113 is a low pass filter.

The voltage/current conversion circuit 124 converts the filter signal S123 from the voltage signal to the current signal Ibe.

The third signal generation circuit 130 generates a proportional current (corrected write current) Ibw (Ibw=Iw−Ib) smaller than the third drive current Iw by which the output power L₀ of the semiconductor laser 50 indicated by the light reception signal Vp becomes the write power level Pw by exactly the first drive current Ib output from the first signal generation circuit 110 based on the signal S135 indicating the multiple m from the multiple setting circuit 135.

The reason for the generation of the corrected third drive current (or corrected write drive current) I_{bw} smaller than the third drive current Iw by exactly the first drive current Ib in the third signal generation circuit 130 is that the first drive current I_{b} output from the first signal generation circuit 110 is added to the current signal I_{bw} output from the third signal generation circuit 130 in the adder circuit 145 in the signal composing circuit 140.

In the third signal generation circuit 130, the multiplier circuit 136 multiplies the filter signal S123 output from the second signal generation circuit 120 by the multiple m indicated by the output signal S135 of the multiple setting circuit 135 to generate a multiplication result signal S136.

The multiple setting circuit 135 generates a multiple setting signal S135 indicating the multiple m defined by the following equation and outputs the same to the multiplier circuit 136:

m=(Pw−Pb)/(Pe−Pb) (1)

where,

Pw is the write power level of the semiconductor laser 50,

Pb is the bias power of the semiconductor laser 50, and

Pe is the erase power of the semiconductor laser 50.

The voltage/current conversion circuit 134 converts the multiplication signal S136 of the multiplier circuit 136 from a voltage signal to the current signal Ibw.

The anode of the semiconductor laser 50 receives as input the drive signal Id from the signal composing circuit 140. The cathode is grounded and becomes the ground potential GND. This semiconductor laser 50 emits the laser beam with the laser power L₀ in accordance with the drive current Id.

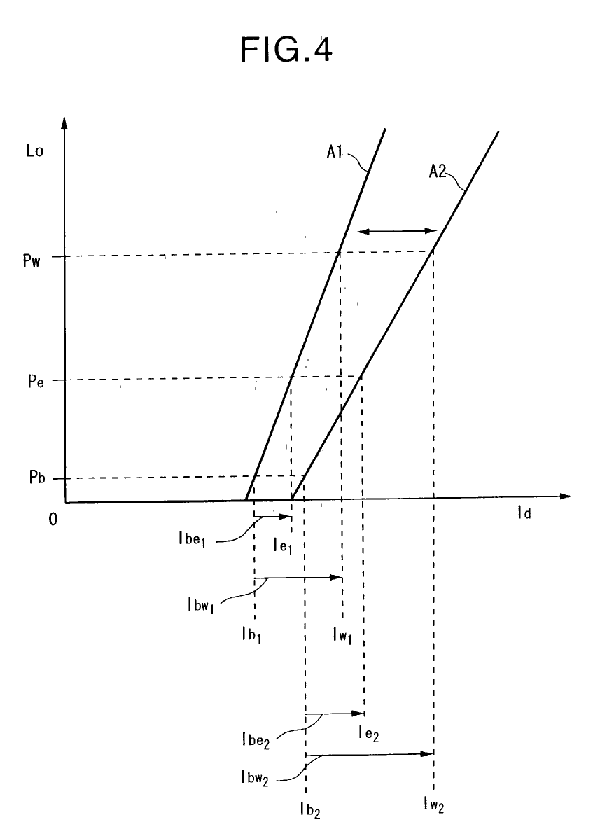

FIG. 4 is a graph of the characteristics of the semiconductor laser 50 in FIG. 3. The abscissa of this graph indicates the drive current Id, and the ordinate indicates the laser power L₀.

The characteristics of the semiconductor laser 50 sometimes change according to the temperature, aging, etc. Such change is illustrated by the curves A1 and A2. Of course, the change of the characteristics of the semiconductor laser 50 is not limited to only the two curves A1 and A2 illustrated in FIG. 4. Further, the characteristics between the curves A1 and A2 or the characteristic indicated by other curves resembling the curves A1 and A2 according to temperature and aging are shown.

The laser drive circuit 190 illustrated in FIG. 3 drives the semiconductor laser 50 in which a change in characteristics occurs due to temperature and aging illustrated in FIG. 4.

In the curve A1, the following characteristics are exhibited:

When the drive current Id=Ib₁, laser power L₀=Pb.

When the drive current Id=Ie₁, laser power L₀=Pe.

When the drive current Id=Iw₁, laser power L₀=Pw.

In the curve A2, the following characteristics are exhibited:

When the drive current Id=Ib₂, laser power L₀=Pb.

When the drive current Id=Ie₂, laser power L₀=Pe.

When the drive current Id=Iw₂, laser power L₀=Pw.

In FIG. 4, Ie₁−Ib₁=Ibe₁ is set, and Iw₁−Ib₁=Ibw₁ is set. Further, Ie₂−Ib₂=Ibe₂ is set, and Iw₂−Ib₂=Ibw₂ is set.

The drive currents Ib₁ and Ib₂ indicate the output current Ib of the voltage/current conversion circuit 114 in the first signal generation circuit 110 when the laser power L₀=Pb.

When the characteristic of the semiconductor laser 50 is the curve A1, the first signal generation circuit 110 in FIG. 3 detects the output power of the semiconductor laser 50 at that time by the light receiving element 51 and performs feedback control so that the output current Ib becomes equal to the first drive current Ib₁. Also, when the characteristic of the semiconductor laser 50 is the curve A2, the first signal generation circuit 110 in FIG. 3 detects the output power of the semiconductor laser 50 at that time by the light receiving element 51 and performs feedback control so that the output current Ib becomes equal to the corresponding first drive current Ib₂.

Currents Ibe₁ and Ibe₂ indicate the output current Ibe of the voltage/current conversion circuit 124 in the second signal generation circuit 120 when the laser power L₀=Pe.

When the characteristic of the semiconductor laser 50 is the curve A1, the second signal generation circuit 120 in FIG. 3 detects the output power of the semiconductor laser 50 at that time by the light receiving element 51 and performs feedback control so that the output current Ibe becomes equal to the differential current Ibe₁. Also, when the characteristic of the semiconductor laser 50 is the curve A2, the second signal generation circuit 120 in FIG. 3 detects the output power of the semiconductor laser 50 at that time by the light receiving element 51 and performs feedback control so that the output current Ibe becomes equal to the differential current Ibe₂.

Currents Ibw₁ and Ibw₂ indicate the output current Ibw of the voltage/current conversion circuit 134 in the third signal generation circuit 130 when the laser power L₀=Pw.

When the characteristic of the semiconductor laser 50 is the curve A1, the third signal generation circuit 130 in FIG. 3 detects the output power of the semiconductor laser 50 at that time by the light receiving element 51 and performs feedback control so that the output current Ibw becomes equal to the proportional current Ibw₂. Also, when the characteristic of the semiconductor laser 50 is the curve A2, the third signal generation circuit 130 in FIG. 3 detects the output power of the semiconductor laser 50 at that time by the light receiving element 51 and performs feedback control so that the output current Ibw becomes equal to the proportional current Ibw₂.

The curves A1 and A2 of the semiconductor laser 50 are straight lines or substantially straight lines when 0<L₀. The slopes of the straight lines are different between the curves A1 and A2. For this reason, the following equation 2 stands. Namely, the proportion (Ibw₁/Ibe₁) is equal to the proportion (Ibw₂/Ibe₂) and equals the multiple m defined by Equation 1, that is, (Pw−Pb)/(Pe−Pb).

$$\begin{matrix}{Ibw}_{1} / {Ibe}_{1} = {Ibw}_{2} / {Ibe}_{2} \\ = ( Pw - Pb ) / ( Pe - Pb )\end{matrix} \qquad ( 2 )$$

By utilizing Equation 2, even if the characteristic of the semiconductor laser 50 changes, the output currents Ibw₁ and Ibw₂ of the voltage/current conversion circuit 134 in the third signal generation circuit 130 can be calculated from the output currents Ibe₁ and Ibe₂ of the voltage/current conversion circuit 124 in the second signal generation circuit 120.

Further, by multiplying the input signal of the voltage/current conversion circuit 124 by the ratio (multiple) m indicated by Equation 2, the input signal of the voltage/current conversion circuit 134 can be generated.

Concretely explaining this, by setting the multiple m indicated by the output signal S135 of the multiple setting circuit 135 to the multiple {(Pw−Pb)/(Pe−Pb)} defined by Equation 2 and multiplying the multiple with the filter signal S123 in the multiplier circuit 136, the multiplication signal S136 of the input signal of the voltage/current conversion circuit 134 can be generated.

In the laser drive circuit 190 illustrated in FIG. 3, in comparison with the laser drive circuit 90 of FIG. 2, the sample and hold circuit and the loop filter are deleted from the third signal generation circuit 130 and the number of the switching circuits of the signal composing circuit 140 is smaller by one, so the circuit configuration becomes simpler.

In the laser drive circuit 190 of FIG. 3, the filter signal S123 input to the voltage/current conversion circuit 124 is multiplied by the output signal S135 of the multiple setting circuit 135 in the multiplier circuit 136 in the third signal generation circuit 130 to generate the multiplication signal S136, and this multiplication signal S136 is input to the voltage/current conversion circuit 134, so it is possible to make the ratio of the current Ibw and the current Ibe correctly match with the multiple of Equation 2.

Second Embodiment

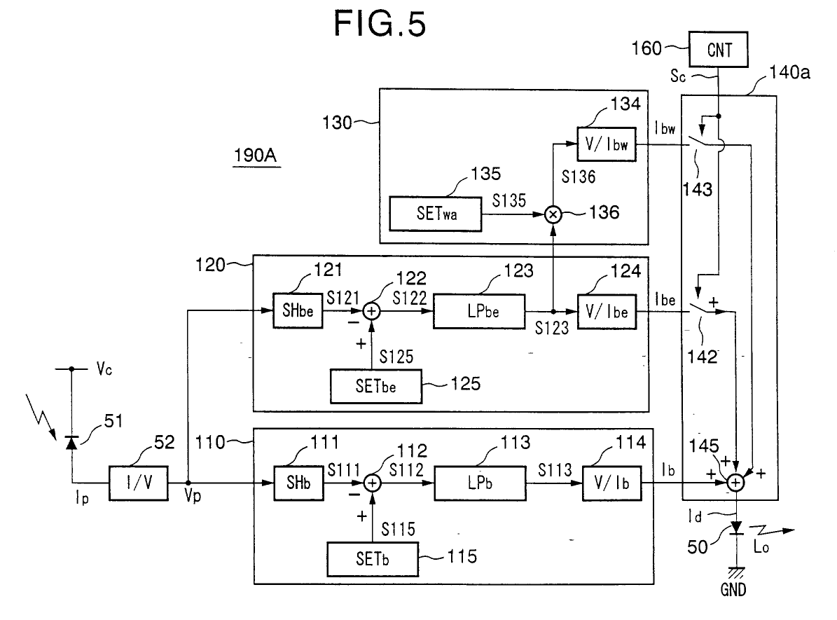

FIG. 5 is a view of the configuration of a second embodiment of the laser drive circuit of the present invention.

A laser drive circuit 190A illustrated in FIG. 5 uses a signal composing circuit 140A wherein the adder circuit 144 in the signal composing circuit 140 illustrated in FIG. 3 is omitted, and the outputs of the switching circuits 142 and 143 are directly input to an adder circuit 145a. The rest of the circuit configuration is similar to that of the laser drive circuit 190 explained by referring to FIG. 3.

As explained above, only one of the switching circuit 142 or 143 is ON/OFF controlled. The other becomes the OFF state. Therefore, the outputs of the switching circuits 142 and 143 can be directly supplied to the adder circuit 145a. By this, the laser drive circuit 190A of FIG. 5 becomes further simpler in circuit configuration than the laser drive circuit 190 illustrated in FIG. 3.

Third Embodiment

The case where the first to third signal generation circuits 110, 120, and 130 and signal composing circuits 140 and 140A comprising the laser drive circuits 190 and 190A illustrated in FIG. 3 and FIG. 5 were comprised as circuits was explained, but it is also possible to realize these circuits by software processing by a computer or signal processing by a digital signal processor (DSP) or by designing a dedicated signal processing integrated circuit.

In that case, the computer etc. perform the signal processing of the components of the circuits illustrated in FIG. 3 and FIG. 5.

Next, the case where a computer is used will be explained. Note that the controlling means 160 can also be realized by using the computer.

Laser Drive Method

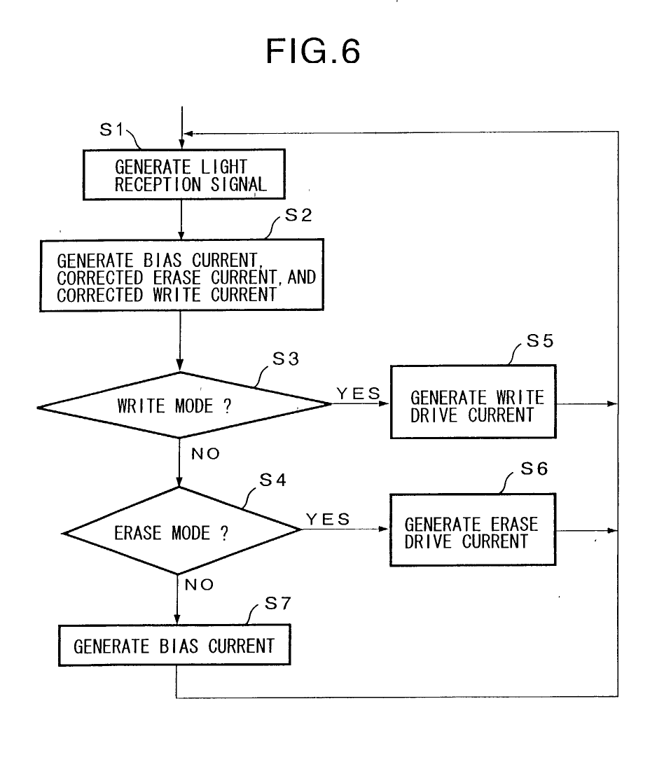

FIG. 6 is a flowchart of a laser drive method showing the processing in the case where the signal processings of the laser drive circuits 190 and 190A of FIG. 3 and FIG. 5 are executed by a computer, DSP, or the like.

Step S1: Generation of Light Reception Signal

The light receiving element 51 receives part of the output laser beam of the semiconductor laser 50 and generates the light reception signal Ip of the current signal.

The current/voltage conversion circuit 52 converts the light reception signal Ip of a current signal to a light reception signal Vp of a voltage signal.

Step S2: Generation of Drive Current

The signal processings of the first to third signal generation circuits 110, 120, and 130 of FIG. 3 and FIG. 5 are independently and simultaneously carried out. Note that, when the following operations of the first to third signal generation circuits 110, 120, and 130 are executed by using a computer, DSP. or the like, the operations of the first to third signal generation circuits 110, 120, and 130 are sequentially carried out. This is because they cannot be completely simultaneously carried out by a computer etc. High speed processing is carried out and the computation is carried out within one sampling period, therefore, substantially, this equals the processings being simultaneously carried out. The sequence of the processing of the first signal generation circuit and the processing of the second signal generation circuit is not important. However, the third signal generation circuit performs the computation by using the result of the second signal generation circuit, so the processing of the third signal generation circuit is desirably carried out after the processing of the second signal generation circuit.

As the processing of the first signal generation circuit 110, the computer calculates the deviation (S115−S111) between the first target signal S115 indicating the target value of the sample value of the light reception signal Vp and the signal S111 indicating the sample value of the light reception signal Vp and generates the first drive current corresponding to the bias power Pb, that is, the bias current based on that deviation as explained above.

As the processing of the second signal generation circuit 120, the computer calculates the deviation (S125−S121) between the second target signal S125 indicating the target value of the sample value of the light reception signal Vp and the signal S121 indicating the sample value of the light reception signal Vp and generates a first differential current smaller than the second drive current corresponding to the erase power Pe by exactly the first drive current, that is, the corrected erase current based on that deviation.

As the processing of the third signal generation circuit 130, the computer calculates a value {(S125−S121)·(Pw−Pb)/(Pe−Pb)} obtained by multiplying the deviation (S125−S121) found at the second signal generation circuit by the multiple m and generates a second differential current (proportional current) smaller than the third drive current corresponding to the write power Pw by exactly the first drive current based on that result.

When a computer is used, the above multiplication processing is very easy.

Steps S3, S4: Decision of Operation Mode

The controlling means 160 detects the operation mode at present in the optical disk device so that a drive current in accordance with the mode is supplied to the semiconductor laser 50.

The controlling means 160 decides whether or not the target value of the laser power L₀ indicating that the operation mode of the optical disk device is the write mode is the write power Pw, and whether or not the target value of the laser power L₀ indicating that the operation mode is the erase mode is the erase power Pe. The bias mode is set in a mode other than this.

When deciding the operation mode, either of the following processings is carried out.

Step S5: Generation of Write Drive Current

The controlling means 160 adds the first drive current Ib and the corrected third write current Iwb so that the target value of the laser power L₀ becomes the write power Pw.

Step S6: Generation of Erase Drive Current

The controlling means 160 adds the first drive current Ib and the corrected second erase current Ibe so that the target value of the laser power L₀ becomes the erase power Pe.

Step S7: Generation of Bias Drive Current

The controlling means 160 outputs only the first drive current Ib so that the target value of the laser power L₀ becomes the bias power Pb.

The controlling means 160 repeats the above processings.

Note that, in the optical disk device having the laser drive circuit 190, the multiple is read from the optical disk recorded with data indicating the multiple of Equation 2 in advance in the controlling means 160 and the read multiple is set in the multiple setting circuit 135.

The optical disk can be for example a phase change type DVD-RW or DVD-RAM too.

The above embodiments are examples of the present invention. The present invention is not limited to the embodiments.

For example, the above laser drive circuit is not limited to application to an optical disk device. The above laser drive circuit can be applied as a current generation circuit also in the case of generating three types of drive signals in a predetermined linear relationship.

As explained above, according to the present invention, the circuit configuration of a current generation circuit such as a laser drive circuit making a semiconductor laser output three or more types of laser power can be simplified. As a result, for example, when using the laser drive circuit of the present invention, the configuration of the optical disk device becomes simpler.

Also, according to the present invention, a current generation circuit or a method useable in the current generation device can be provided.

### INDUSTRIAL APPLICABILITY

The laser drive circuit of the present invention can be applied as the drive circuit of a semiconductor laser in an optical disk device. Also, the drive current generation circuit of the present invention can be applied as a circuit for generating current for driving a drive device like a semiconductor laser used in a linear region while having nonlinear characteristics.

LIST OF REFERENCES

| | |
|---|---|
| 50 | semiconductor laser, |
| 51 | light receiving element, |
| 52 | current/voltage conversion circuit |
| 110, 120, 130 | first to third signal generation circuits, |
| 111, 121 | sample and hold circuit, |
| 112, 122 | adder (subtractor) circuit |
| 113, 123 | loop filter |
| 114, 124, 134 | voltage/current conversion circuit |
| 115, 15 | target setting circuit |
| 135 | multiple setting circuit |
| 136 | multiplication circuit |
| 142, 143 | switching circuit |
| 144, 145 | adder circuit |
| 190 | laser drive circuit |
| Id | drive current |
| L₀ | laser power |

1. A current generation circuit comprising:
a first signal generation circuit receiving as input a signal indicating an operation state of a drive device having a nonlinear operation characteristic and used in a characteristic portion indicated by a straight line and generating a first drive current by which an output power of said drive device indicated by said signal indicating an operation state becomes a first power level based on a first target value,
a second signal generation circuit receiving as input a signal indicating an operation state of said drive device and generating a corrected second drive current smaller than said first drive current from a second drive current by which the output power of said semiconductor laser indicated by said signal indicating the operation state becomes a second power level higher than said first power level based on a second target value,
a third signal generation circuit for generating a corrected third drive current smaller than said first drive current from a third drive current by which the output power of said drive device becomes a third power level higher than said second power level by multiplying said corrected second drive current with a predetermined multiple, and
a signal composing circuit having a first switching circuit for selecting the output signal of said third signal generation circuit, a second switching circuit for selecting the output signal of said second signal generation circuit, and an adder circuit for adding the signal selected by said first switching circuit, the signal selected by the second switching circuit, and the output of said first signal generation circuit and supplying the result of the adder circuit to said drive device, in said signal composing circuit said first and second switching circuits being OFF in a first operation mode, said first switching circuit being in an ON state and said second switching circuit being OFF in a second operation mode, and said first switching circuit being OFF and said second switching circuit becoming the ON state in a third operation mode.

2. A current generation circuit as set forth in claim 1, wherein the signal composing circuit further has a second adder circuit for adding the signal selected by said first switching circuit and the signal selected by the second switching circuit and outputting the result to said adder circuit.

3. A current generation circuit as set forth in claim 1 or 2, wherein the predetermined multiple is defined by the following equation:
(Third power level−first power level)/(Second power level−first power level)

4. A laser drive circuit comprising:
a first signal generation circuit for receiving as input a light reception signal from a light receiving element generating a light reception signal in accordance with light emitted from a semiconductor laser and generating a first semiconductor laser drive current by which the output power of said semiconductor laser indicated by said light reception signal becomes a first power level based on a first target value,
a second signal generation circuit receiving as input said light reception signal and generating a corrected second drive current smaller than said first semiconductor laser drive current from a second semiconductor laser drive current by which the output power of said semiconductor laser indicated by said light reception signal becomes a second power level higher than said first power level based on a second target value,
a third signal generation circuit for generating a corrected third drive current smaller than said first semiconductor laser drive current from a third semiconductor laser drive current by which the output power of said semiconductor laser becomes a third power level higher than said second power level by multiplying said corrected second drive current by a predetermined multiple, and
a signal composing circuit having a first switching circuit for selecting the output signal of said third signal generation circuit, a second switching circuit for selecting the output signal of said second signal generation circuit, and an adder circuit for adding the signal selected by said first switching circuit, the signal selected by the second switching circuit, and the output of said first signal generation circuit and supplying the result of the adder circuit to the semiconductor laser, in which signal composing circuit said first and second switching circuits are OFF in a first operation mode, said first switching circuit is in an ON state and said second switching circuit is OFF in a second operation mode, and said first switching circuit is OFF and said second switching circuit becomes the ON state in a third operation mode.

5. A laser drive circuit as set forth in claim 4, wherein the signal composing circuit further comprises a second adder circuit for adding the signal selected by said first switching circuit and the signal selected by the second switching circuit and outputting the result to said adder circuit.

6. A laser drive circuit as set forth in claim 4 or 5, wherein the predetermined multiple is defined by the following equation:
(Third power level−first power level)/(Second power level−first power level)

7. A laser drive circuit as set forth in claim 4 or 5, wherein said first signal generation circuit comprises:
a first sample and hold circuit for sampling said light reception signal,
a first target value setting circuit for outputting a first semiconductor laser drive current by which the output power of the semiconductor laser indicated by the light reception signal becomes a first power level as a first target value, and
a first subtractor circuit for subtracting the output signal of said first sample and hold circuit from said first target value to generate a first differential signal and
outputs said first differential signal as said first drive current.

8. A laser drive circuit as set forth in claim 4 or 5, wherein said second signal generation circuit comprises:
a second sample and hold circuit for sampling said light reception signal,
a second target value setting circuit for outputting a second semiconductor laser drive current by which the output power of the semiconductor laser indicated by the light reception signal becomes a second power level as a second target value, and
a second subtraction circuit for subtracting the output signal of said second sample and hold circuit from said second target value to generate a second differential signal and
outputs said second differential signal as said second corrected drive current.

9. A laser drive circuit as set forth in claim 8, wherein said second signal generation circuit
further comprises a filter for passing a low band component of said second differential signal of the output of said subtraction circuit and
outputs a signal passing through said filter as said second corrected drive current.

10. A laser drive circuit as set forth in claim 8 or 9, wherein said third signal generation circuit comprises:
a multiple generation circuit for outputting a multiple for generating a corrected third drive current smaller than said first semiconductor laser drive current from a third semiconductor laser drive current by which the output power of said semiconductor laser becomes a third power level higher than said second power level and
a multiplication circuit for multiplying said corrected second drive current generated at said second signal generation circuit by a multiple output from said multiple generation circuit and
outputs said multiplication result as said third drive current.

11. A laser drive circuit as set forth in claim 4 or 5, wherein
the laser drive circuit is used in an optical disk device,
the laser beam emitted from said semiconductor laser is focused on a phase change type optical disk and said light receiving element,
said first power level is the level of the bias power,
said second power level is the level of the erase power for erasing the data recorded on said optical disk,
said third power level is the level of the write power for recording the data on said optical disk,
said first operation mode is the mode for driving said semiconductor laser at the level of said bias power,
said second operation mode is the mode for driving said semiconductor laser at the level of said erase power,
said third operation mode is the mode for driving said semiconductor laser by said write level, and
said first and second switching circuits are driven ON or OFF in accordance with an erase pulse waveform and a write waveform.

12. An optical disk device comprising:
a phase change type optical disk,
a semiconductor laser for focusing a laser beam on the optical disk,
a light receiving element for generating a light reception signal in accordance with the emitted light of the semiconductor laser,
a controlling means for controlling reading of the data from said optical disk, erasure of the data on said optical disk, and writing of the data to said optical disk,
a first signal generation circuit for receiving as input a light reception signal from said light receiving element and generating a first semiconductor laser drive current by which the output power of said semiconductor laser indicated by said light reception signal becomes a first power level based on a first target value,
a second signal generation circuit receiving as input said light reception signal and generating a corrected second drive current smaller than said first semiconductor laser drive current from a second semiconductor laser drive current by which the output power of said semiconductor laser indicated by said light reception signal becomes a second power level higher than said first power level based on a second target value,
a third signal generation circuit for generating a corrected third drive current smaller than said first semiconductor laser drive current from a third semiconductor laser drive current by which the output power of said semiconductor laser becomes a third power level higher than said second power level by multiplying said corrected second drive current by a predetermined multiple, and
a signal composing circuit having a first switching circuit for selecting the output signal of said third signal generation circuit, a second switching circuit for selecting the output signal of said second signal generation circuit, and an adder circuit for adding the signal selected by said first switching circuit, the signal selected by the second switching circuit, and the output of said first signal generation circuit and supplying the result of the adder circuit to the semiconductor laser,
said controlling means
making said first and second switching circuits turn OFF in said read mode of data,
making said first switching circuit turn ON or OFF in accordance with an erase waveform in a state where said second switching circuit is turned OFF in said erase mode, and
making said second switching circuit turn ON or OFF in accordance with a write waveform in a state where said first switching circuit is turned OFF in said write mode.

13. An optical disk device as set forth in claim 12, wherein the signal composing circuit further has a second adder circuit for adding the signal selected by said first switching circuit and the signal selected by the second switching circuit and outputting the result to said adder circuit.

14. An optical disk circuit as set forth in claim 12 or 13, wherein the predetermined multiple is defined by the following equation:
(Third power level−first power level)/(Second power level−first power level)

15. A laser drive device comprising:
a first signal generation means for receiving as input a light reception signal from a light receiving element generating a light reception signal in accordance with light emitted from a semiconductor laser and generating a first semiconductor laser drive current by which the output power of said semiconductor laser indicated by said light reception signal becomes a first power level based on a first target value,
a second signal generation means receiving as input said light reception signal and generating a corrected second drive current smaller than said first semiconductor laser drive current from a second semiconductor laser drive current by which the output power of said semiconductor laser indicated by said light reception signal becomes a second power level higher than said first power level based on a second target value,
a third signal generation means for generating a corrected third drive current smaller than said first semiconductor laser drive current from a third semiconductor laser drive current by which the output power of said semiconductor laser becomes a third power level higher than said second power level by multiplying said corrected second drive current by a predetermined multiple, and
a signal composing means having a first switching means for selecting the output signal of said third signal generation means, a second switching means for selecting the output signal of said second signal generation means, and an adder means for adding the signal selected by said first switching means, the signal selected by the second switching means, and the output of said first signal generation means and supplying the result of the adder means to the semiconductor laser, in which signal composing means said first and second switching means are OFF in a first operation mode, said first switching means is in an ON state and said second switching means is OFF in a second operation mode, and said first switching means is OFF and said second switching means becomes ON in a third operation mode.

16. A laser drive device as set forth in claim 15, wherein said signal combining means further comprises a second adder means for adding the signal selected by said first switching means and the signal selected by the second switching means and outputting the result to said adder means.

17. A laser drive device as set forth in claim 15 or 16, wherein the predetermined multiple is defined by the following equation:
(Third power level−first power level)/(Second power level−first power level)

18. An optical disk device comprising:
a phase change type optical disk,
a semiconductor laser for focusing a laser beam on an optical disk,
a light receiving element for generating a light reception signal in accordance with the emitted light of the semiconductor laser,
a controlling means for controlling reading of the data from said optical disk, erasure of the data on said optical disk, and writing of the data to said optical disk,
a first signal generation circuit for receiving as input a light reception signal from said light receiving element and generating a first semiconductor laser drive current by which the output power of said semiconductor laser indicated by said light reception signal becomes a bias power level based on a first target value,
a second signal generation circuit receiving as input said light reception signal and generating a corrected second drive current smaller than said first semiconductor laser drive current from a second semiconductor laser drive current by which the output power of said semiconductor laser indicated by said light reception signal becomes an erase power level from said bias power level based on a second target value,
a third signal generation circuit for generating a corrected third drive current smaller than said first semiconductor laser drive current from a third semiconductor laser drive current by which the output power of said semiconductor laser becomes a write power level higher than said erase power level by multiplying said corrected second drive current by a predetermined multiple, and
a signal composing circuit having a first switching means for selecting the output signal of said third signal generation circuit, a second switching means for selecting the output signal of said second signal generation circuit, and an adder circuit for adding the signal selected by said first switching means, the signal selected by the second switching means, and the output of said first signal generation circuit and supplying the result of the adder circuit to the semiconductor laser,
said controlling means
making said first and second switching means turn OFF in said read mode of data,
making said first switching means turn ON or OFF in accordance with an erase waveform in a state where said second switching means is turned OFF in said erase mode, and
making said second switching means turn ON or OFF in accordance with a write waveform in a state where said first switching means is turned OFF in said write mode.

19. An optical disk device as set forth in claim 18, wherein the signal composing circuit further has a second adder circuit for adding the signal selected by said first switching circuit and the signal selected by the second switching circuit and outputting the result to said adder circuit.

20. An optical disk device as set forth in claim 18 or 19, wherein the predetermined multiple is defined by the following equation:
(Third power level—first power level)/(Second power level—first power level)

21. A laser drive method including:
a step of inputting a light reception signal from a light receiving element generating a light reception signal in accordance with light emitted from a semiconductor laser,
a step of generating a first semiconductor laser drive current by which the output power of said semiconductor laser indicated by said input light reception signal becomes a first power level based on the first target value, generating a corrected second drive current smaller than said first semiconductor laser drive current from a second semiconductor laser drive current by which the output power of said semiconductor laser indicated by said light reception signal becomes a second power level higher than said first power level based on the second target value, and generating a corrected third drive current smaller than said first semiconductor laser drive current from a third semiconductor laser drive current by which the output power of said semiconductor laser becomes a third power level higher than said second power level by multiplying said corrected second drive current by a predetermined magnitude, and
a step of outputting said first semiconductor laser drive current in a first operation mode, adding said first semiconductor laser drive current and said corrected second drive current and outputting the same in a second mode, and adding said first semiconductor laser drive current and said corrected third drive current and outputting the same in a third mode.
